(19) United States
(12) Patent Application Publication
(10) Pub. No.: US 2011/0138766 A1
(43) Pub. Date: Jun. 16, 2011

(54) SYSTEM AND METHOD OF IMPROVING EMISSION PERFORMANCE OF A GAS TURBINE

(75) Inventors: Ahmed Mostafa ELKady, Niskayuna, NY (US); Andrei Tristan Evulet, Clifton Park, NY (US); Geir Johan Rørtveit, Ranheim (NO); Hejie Li, Schenectady, NY (US); Matthias Finkenrath, Garching n. Munich (DE)

(73) Assignee: GENERAL ELECTRIC COMPANY, SCHENECTADY, NY (US)

(21) Appl. No.: 12/637,783

(22) Filed: Dec. 15, 2009

(51) Int. Cl. F02C 9/00; F02C 7/08

(52) U.S. Cl. 60/39.24; 60/39.52

(57) ABSTRACT

A method of improving emission performance of a gas turbine is provided. The method includes recirculating a portion of an exhaust gas stream to a compressor of the gas turbine via an exhaust gas recirculating system, to reduce concentration of oxygen in a high pressure feed oxidant stream into a combustor of the gas turbine. The method further includes adding diluent to at least one of a fuel stream directed to the combustor or a low pressure feed oxidant stream directed to the compressor, to reduce concentration of oxides of nitrogen (NOx) and increase concentration of carbon dioxide in a resultant exhaust gas stream.

### BACKGROUND

The invention relates generally to emission reduction and more particularly, to emission reduction in gas turbine engines.

Oxides of Nitrogen (NOx) are major pollutants found inherently in an exhaust gas stream of combustion engines. They are known to cause acid rains that are harmful to living organisms. Several emission reduction technologies, such as, but not limited to, premixed combustion, exhaust gas recirculation (EGR), steam addition in diffusion combustion, reheat combustion and selective catalytic reduction (SCR) have been employed to reduce NOx emissions.

In premixed combustion, for example, a feed oxidant stream is mixed with a fuel prior to being introduced into a combustor. In such a case, the fuel is uniformly mixed with combustion air and excess air available helps to keep the flame temperatures low. Low flame temperatures in turn reduce NOx formation.

In exhaust gas recirculation (EGR), a part of an exhaust gas stream is re-circulated back into the feed oxidant stream, effectively reducing oxygen concentration in the feed oxidant stream. Lack of excess oxygen in the combustor reduces the formation of NOx. Reheat combustion is similar to EGR, but here the combustion products of a first combustor are reheated or re-combusted in a sequential second combustor. Thus, the formation of NOx is reduced due to lack of excess oxygen in the second sequential combustor, reheating the combustion product of the first combustor.

Furthermore, steam addition into a diffusion flame quenches the diffusion flame temperatures. Steam addition enables reducing the flame temperatures to a desirable limit, thus reducing the formation of NOx. In Selective Catalytic Reduction (SCR), reduction agent like ammonia, for example, is employed to reduce the oxides of nitrogen in exhaust gas stream into elemental nitrogen.

However, employing the aforementioned emission reduction technologies reduce NOx concentration in exhaust gas stream to about 9 ppm. With the growing concern for cleaner environment and stricter emission regulations, further reduction of NOx concentration in exhaust gas streams of combustion engines is highly desirable.

Furthermore, there is a growing concern towards global warming Carbon dioxide emission from combustion engines is attributed be the biggest contributor towards global warming Technologies like carbon capture and carbon storage are proven to effectively reduce carbon dioxide concentration in the exhaust gas stream. Carbon capture techniques work more efficiently and cost effectively with increased concentration of carbon dioxide in the exhaust gas stream.

Therefore, there is a need for improved emission reduction technologies that addresses one or more of the aforementioned issues and enables effective use of carbon capture technologies.

### BRIEF DESCRIPTION

In accordance with an embodiment of the invention, a method of improving emission performance of a gas turbine is provided. The method includes recirculating a portion of an exhaust gas stream to a compressor of the gas turbine via an exhaust gas recirculating system, to reduce concentration of oxygen in a high pressure feed oxidant stream into a combustor of the gas turbine. The method further includes adding diluent to at least one of a fuel stream directed to the combustor or a low pressure feed oxidant stream directed to the compressor, to reduce concentration of oxides of nitrogen (NOx) and increase concentration of carbon dioxide in a resultant exhaust gas stream.

In accordance with another embodiment of the invention, a method of improving emission performance of a gas turbine is provided. The method includes recirculating a portion of an exhaust gas stream to a compressor of the gas turbine via an exhaust gas recirculating system, to reduce concentration of oxygen in a high pressure feed oxidant stream into a combustor of the gas turbine. The method further includes adding diluent to a fuel stream directed to a premix chamber and combusting the fuel-diluent mixture in a premix combustor to reduce the concentration of oxides of nitrogen (NOx) and increase the concentration of carbon dioxide in a resultant exhaust gas stream.

In accordance with another embodiment of the invention, a system for improved emission performance of a gas turbine is provided. The system includes an exhaust gas re-circulating system configured to re-circulate an exhaust gas stream to a compressor of the gas turbine, to reduce concentration of oxygen in a high pressure feed oxidant stream into a combustor of the gas turbine. The system further includes a diluent-addition system configured to add a diluent to at least one of a fuel stream directed to the combustor or a low pressure feed oxidant stream directed to the compressor, to reduce the concentration of oxides of nitrogen (NOx) and increase the concentration of carbon dioxide in a resultant exhaust gas stream.

In accordance with another embodiment of the invention, a system for improved emission performance of a gas turbine is provided. The system includes an exhaust gas recirculation system configured to recirculate a portion of an exhaust gas stream to a compressor of the gas turbine, to reduce concentration of oxygen in a high pressure feed oxidant stream into a combustor of the gas turbine. The system further includes a diluent addition system configured to add a diluent to a fuel stream directed to a premix chamber within the combustor, to reduce the concentration of oxides of nitrogen (NOx) and increase concentration of carbon dioxide in a resultant exhaust gas stream.

In accordance with another embodiment of the invention, a system for improved emission performance in power generation is provided. The system includes at least two gas turbine engines. The system further includes a diluent addition system configured to add a diluent to at least one of a fuel stream at a first and second gas turbine combustor intake or a low pressure feed oxidant stream at a first and second gas turbine compressor intake. The said system further includes an exhaust gas recirculation system configured to recirculate a portion of an exhaust gas stream from a first gas turbine outlet into the first gas turbine compressor intake and circulate another portion of the exhaust gas stream of the first gas turbine at the second gas turbine compressor intake, to reduce concentration of oxygen in a high pressure feed oxidant stream into the first and second gas turbine combustors and hence reduce concentration of oxides of nitrogen (NOx) and increase concentration of carbon dioxide in the exhaust gas streams of the first and second gas turbines.

In accordance with another embodiment of the invention, a retrofit system for improved emission performance of a gas turbine is provided. The retrofit system includes a retrofitable exhaust gas recirculation system, configured to recirculate a portion of an exhaust gas stream to a compressor of the gas turbine, to reduce concentration of oxygen in a high pressure feed oxidant stream into a combustor of the gas turbine. The system further includes a retrofitable diluent addition system configured to add a diluent to at least one of a fuel stream directed to the combustor or a low pressure feed oxidant stream directed to the compressor, to reduce concentration of oxides of nitrogen (NOx) and increase concentration of carbon dioxide in a resultant exhaust gas stream.

In accordance with another embodiment of the invention, a system for improved emission performance of a gas turbine is provided. The system includes at least two combustors. The system further includes an exhaust gas recirculation system configured to recirculate a portion of an exhaust gas stream to a compressor of the gas turbine, to reduce concentration of oxygen in a high pressure feed oxidant stream into one or more of the at least two combustors of the gas turbine. The system further includes a diluent addition system configured to add a diluent to one or more of the at least two combustors of the gas turbine, to reduce the concentration of oxides of nitrogen (NOx) and increase concentration of carbon dioxide in a resultant exhaust gas stream.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of an exemplary emission performance improvement system for a gas turbine engine including an EGR system and steam or water addition system in accordance with an embodiment of the invention.

FIG. 2 is a block diagram representation of an exemplary emission performance improvement system for the gas turbine engine in FIG. 1, including a mixer to mix a fuel stream with a diluent stream.

FIG. 3 is a block diagram representation of a combustor in a gas turbine of FIG. 1 including a mixing chamber for indirect addition of fuel-diluent mixture into a premix chamber of the combustor.

FIG. 4 is a block diagram representation of a combustor in a gas turbine engine of FIG. 1 including direct addition of fuel and diluent into a premix chamber of a combustor.

FIG. 5 is a schematic illustration of an exemplary configuration of multiple gas turbine engines in accordance with an embodiment of the invention.

FIG. 6 is a schematic illustration of an exemplary configuration of multiple combustors in the gas turbine of FIG. 1 including diluent addition.

FIG. 7 is a flow chart illustrating exemplary steps for a method of improving emission performance of a gas turbine engine in accordance with an embodiment of the invention.

FIG. 8 is yet another flow-chart illustrating exemplary steps for a method of improving emission performance of a gas turbine engine in accordance with an embodiment of the invention.

FIG. 9 is an exemplary graphical representation of percentage reduction in NOx formation with increase in exhaust gas recirculation.

FIG. 10 is an exemplary graphical representation of percentage reduction in NOx formation with increase in ratio of water or steam with fuel.

FIG. 11 is an exemplary graphical representation of reduction in NOx concentration with increasing percentage of exhaust gas recirculation and steam or water to fuel ratio.

### DETAILED DESCRIPTION

As described in detail below, embodiments of the present invention provide a system for improving emission performance and a method for operating a gas turbine to reduce oxides of nitrogen (NOx) emission to less than about 3 ppm and increase carbon dioxide concentration by about 10% in an exhaust gas stream of a gas turbine. The term “improving emission performance” used herein refers to reduction of NOx concentration in the exhaust gas stream of the gas turbine. The term “EGR” refers to exhaust gas recirculation in a gas turbine engine. The system includes a combination of the EGR system and a diluent addition system to recirculate a portion of an exhaust gas stream back into a compressor inlet of the gas turbine and add diluent into a combustor of the gas turbine respectively.

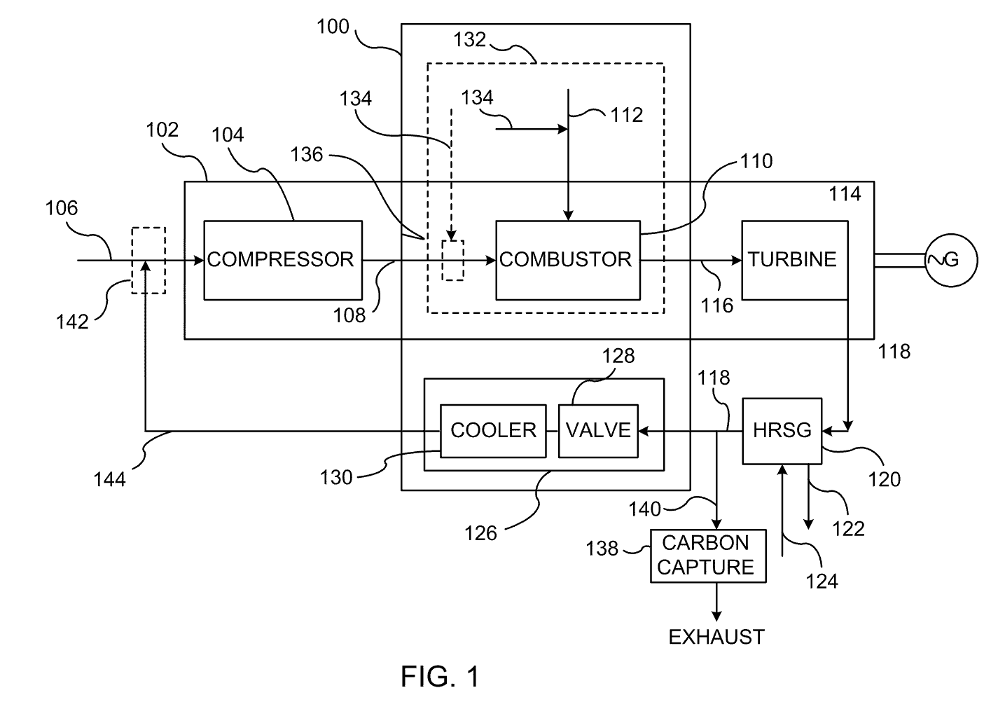

In an illustrated embodiment as shown in FIG. 1, a system 100 for improving emission performance in a gas turbine engine 102 is depicted. The gas turbine 102 includes a compressor 104 to compress a feed oxidant stream 106 and supply high pressure feed oxidant stream 108 to a combustor 110. The combustor 110 combusts the high pressure feed oxidant stream 108 with a fuel stream 112. In one embodiment, the fuel stream 112 includes a liquid fuel or a gaseous fuel. The liquid fuel may include species such as, but not limited to, diesel and heavy fuel oil. Non-limiting examples of the gaseous fuel may include natural gas, synthetic gas and hydrogen. The gas turbine 102 includes a turbine 114 to extract mechanical work from a combustion discharge 116 of the combustor 110. The combustion discharge 116 exits the gas turbine 102 as an exhaust gas stream 118 after flowing through at least one turbine stage of turbine 114. In an exemplary operation of the system 100, a heat recovery steam generator (HRSG) 120 extracts heat from an exhaust gas stream 118 of the gas turbine 102 to generate steam 122 from water 124 directed into the HRSG. An exhaust gas recirculation (EGR) system 126 recirculates a portion of the exhaust gas stream 118 to the compressor 104 of the gas turbine 102, to reduce concentration of oxygen by about 5% in a high pressure feed oxidant stream 108 into the combustor 110 of the gas turbine 102. In one embodiment, the EGR system 126 recirculates less than about 50% of exhaust gas stream 118. In a particular embodiment, the EGR system 126 includes a valve 128 to regulate the flow of exhaust gas stream 118. In another embodiment, the EGR system 126 includes a cooler 130 to cool the exhaust gas stream 118. Further, water present in the exhaust gas stream 118 is condensed in the cooler 130 by a reduction in temperature of the exhaust gas stream 118. The term “HRSG” used herein refers to heat recovery steam generator 120 that recovers heat from the exhaust gas stream 118 to generate steam 122. The steam 122 is typically directed to a steam turbine (not shown) to extract additional work.

Furthermore, a diluent addition system 132 adds a diluent 134 to at least one of a fuel stream 112 to the combustor 110 or to a high pressure feed oxidant stream 108 directed to the combustor 110, to reduce the concentration of oxides of nitrogen (NOx) in the exhaust gas stream 118. In one embodiment, the concentration of oxides of nitrogen (NOx) in the exhaust gas stream 118 is reduced by less than about 3 ppm. In a particular embodiment, the concentration of carbon dioxide is increased by about 10%. In another particular embodiment, the diluent addition system 132 includes a mixer 136 that mixes the diluent 134 with the high pressure feed oxidant stream 108. Non-limiting examples of the diluent 134 may include water and steam.

In operation, NOx formation increases exponentially with the flame temperature and proportionally with the availability of oxygen in the combustor 110. The EGR system 126 recirculates a portion of the exhaust gas stream 118 into the compressor 104 to reduce oxygen content in the feed oxidant stream 106 by about 5%. Due to combustion of the fuel stream 112 and the high pressure feed oxidant stream 108 in the combustor 110 the oxygen content is depleted in the exhaust gas stream 118. Once the exhaust gas stream 118 is mixed with the feed oxidant stream 106, the oxygen content in the mixture is lower in comparison to the oxygen content in a plain feed oxidant stream. This reduction in the oxygen content helps to reduce the formation of NOx in the combustor 110, for example by between about 70% to about 80%.

Furthermore, the addition of the diluent 134 in the combustor 110 helps reduce the flame temperature. The diluent 134 absorbs the heat generated during the combustion of high pressure feed oxidant stream 108 and fuel stream 112, to reduce the flame temperatures within the combustor 110. Hence the formation of NOx is retarded by reduction in flame temperature. The diluent addition 134 in the combustor 110 reduces the formation of NOx, for example by between about 60% to about 70%.

The use of EGR also increases the concentration of carbon dioxide in a resultant exhaust gas stream. In a particular embodiment, the exhaust gas recirculation increases the concentration of carbon dioxide by about 10%. In carbon capture and sequestration the carbon dioxide from the exhaust gas stream 118 is separated and is either stored in geological formations, deep in the oceans or converted into mineral carbonates. Carbon capture and sequestration techniques are more efficient and cost effective with increase in carbon dioxide concentration in the exhaust gas stream 118. In an exemplary embodiment, as illustrated herein, an exhaust gas stream 118 from the outlet of the HRSG 120 is passed through a carbon capture system 138 to reduce the amount of carbon dioxide rejected with the exhaust gas stream 140 into the atmosphere. In another exemplary embodiment, an EGR mixer 142 is provided to mix a recirculated exhaust gas stream 144 with the feed oxidant stream 106.

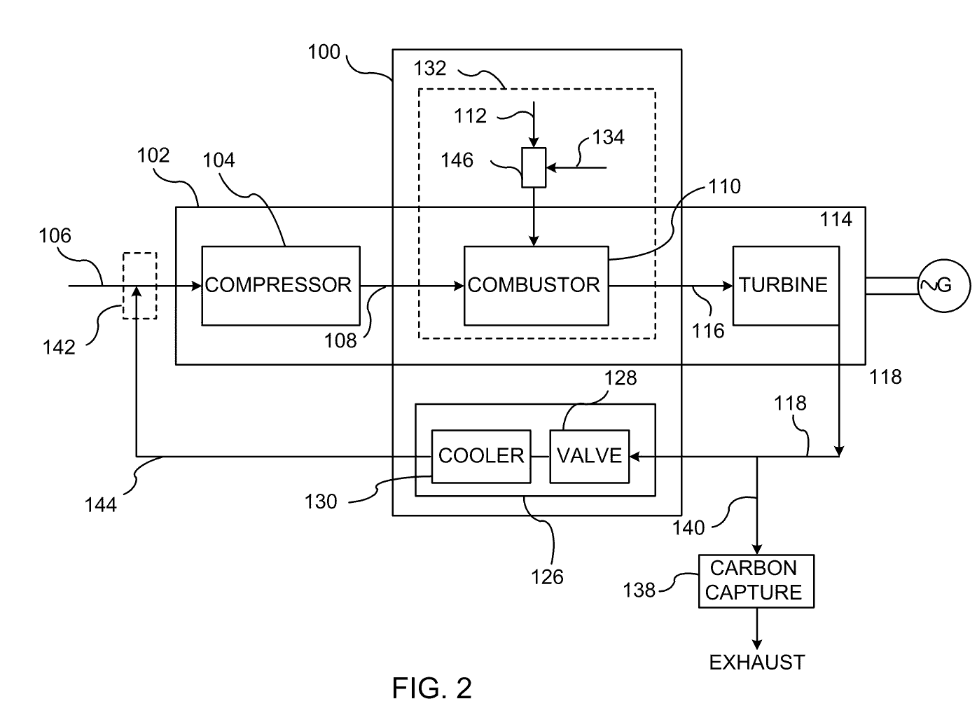

FIG. 2 is a block diagram illustration of the system 100 for improving emission performance in the gas turbine engine 102 in FIG. 1, including a mixer 146 to mix a fuel stream 112 with a diluent stream 134 at an optimal ratio. The ratio of diluent to fuel is less than about 5:1 to prevent lean blowout within the combustor 110. Lean blowout within the combustor 110 may occur due to lower oxygen content in the feed oxidant stream or lower flame temperature due to heat absorption by any excess diluent addition within the combustor 110. In an exemplary operation of the gas turbine, the availability of oxygen in a feed oxidant stream is lowered, for example by between about 5% to about 10%, by exhaust gas recirculation, to reduce the formation of NOx, for example by between about 70% to about 80%. Furthermore, the flame temperature within the combustor 110 is reduced by means of diluent addition 134 to fuel stream 112 further reducing the formation of NOx, for example by between about 80% to 90% in the combustor 110. In accordance with an embodiment of this invention, the ratio of addition of diluent 134 with fuel stream 112 is about 1:1. In a particular embodiment, the combined use of EGR system 126 and diluent addition 134 in the system 100 of FIG. 1 reduces the concentration of NOx in the exhaust gas stream 118, for example to less than about 3 ppm.

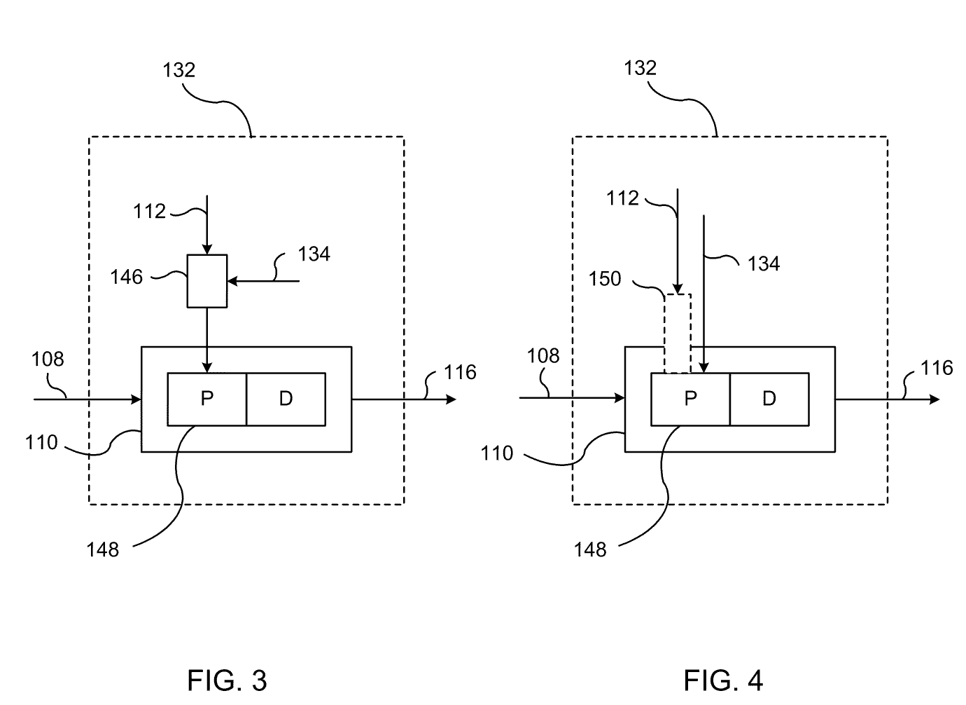

FIG. 3 is a block diagram representation of a combustor 110 in the gas turbine 102 of FIG. 1 including the mixer 146 for indirect addition of fuel-diluent mixture into a premix chamber 148 of the combustor 110. In accordance with an embodiment of this invention, a diluent addition system 132 is provided to add diluent 134 at the premix chamber 148 of the combustor 110. A lean mixture of feed oxidant stream 108 and a fuel stream 112 is formed in the premix chamber 148 before combustion. A lean mixture includes a substantially high concentration of feed oxidant 108 relative to the fuel stream 112 of more than about 2:1 ratio. Furthermore, in an exemplary embodiment, the diluent 134 is added to the fuel stream 112 in a diluent-fuel mixer 146 and thereafter premixed with feed oxidant stream 108 in the premix chamber 148. In accordance with a particular embodiment of this invention, as described in FIG. 2, the diluent-fuel ratio is typically maintained at about 1. The diluent-fuel mixer 146 mixes the diluent 134 and the fuel stream 112 in a ratio of about 1.

FIG. 4 is a block diagram representation of a combustor 110 in a gas turbine 102 of FIG. 1 including a diluent addition system 132 for direct addition of fuel 112 and diluent 134 into a premix chamber 148 of the combustor 110. In accordance with an embodiment of this invention a diluent addition system 132 is provided to add diluent 134 at a premix chamber 148 of a combustor 110. Furthermore, a fuel stream 112 is added to the premix chamber 148 via a fuel injector 150. A feed oxidant stream 108 and the fuel stream 112 is mixed with the diluent 134 at the premixing chamber 148 and thereafter, the mixture is combusted within the premixing chamber 148.

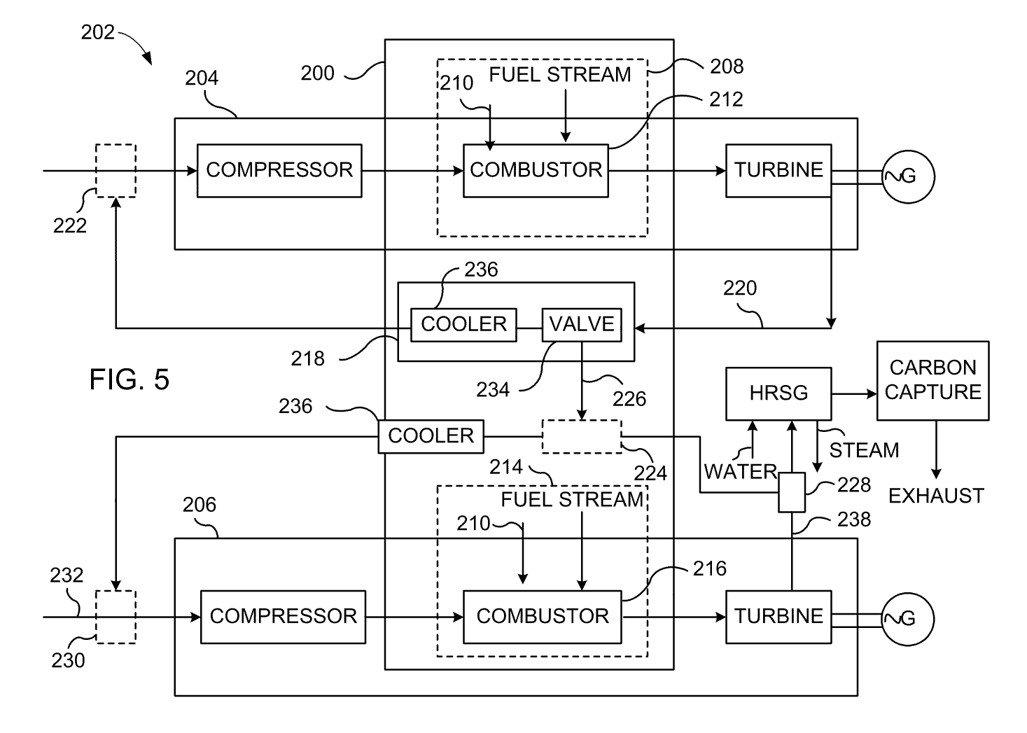

In another illustrated embodiment of the invention as shown in FIG. 5, a system 200 for improving emission performance in a multiple gas turbine power generation system 202 is depicted. The multiple gas turbine power generation system 202 includes at least two gas turbines 204, 206 to produce power. The system 200 for improving emission performance includes a first diluent addition system 208 configured to add diluent stream 210 into a first gas turbine combustor 212 and a second diluent addition system 214 to add the diluent stream 210 into a second gas turbine combustor 216. The system 200 further includes an exhaust gas recirculation system 218 to recirculate less than about 50% of a first gas turbine exhaust gas stream 220 to a first gas turbine intake 222 and further circulate the remainder of the first gas turbine exhaust gas stream 220 to the second gas turbine 206. In a particular embodiment, the EGR system 218 of the system 200 includes a bypass valve 224 to bypass a portion of a remainder exhaust gas stream 226 of the first gas turbine 204 to the exhaust 228 of the second gas turbine 206 to control the addition of exhaust gas stream 226 at a second gas turbine intake 230 along with a second gas turbine feed oxidant stream 232. In another particular embodiment, the EGR system 218 includes a valve 234 to regulate the flow of exhaust gas stream 220. In another embodiment, the EGR system 218 includes a cooler 236 to cool the exhaust gas stream 220. In an exemplary operation of the multiple gas turbine power generation system 202, the addition of diluent stream 210 into the first gas turbine combustor 212 and second gas turbine combustor 216 reduces the concentration of NOx in the exhaust gas streams 220 and 238 of the first and second gas turbines 204 and 206, for example by between about 60% to about 70%. Furthermore, the recirculation of the first gas turbine exhaust gas stream 220 to the first gas turbine intake 222 and circulation of remainder of the exhaust gas stream 226 of the first gas turbine 204 to the second gas turbine intake 230, reduces the NOx concentration in the exhaust gas streams 220 and 238 of the first and second gas turbine 204 and 206, for example by between about 80% to about 90%. In a particular embodiment, the system 200 reduces the concentration of NOx in the exhaust gas streams 204 and 206, for example to less than about 3 ppm to about 1 ppm.

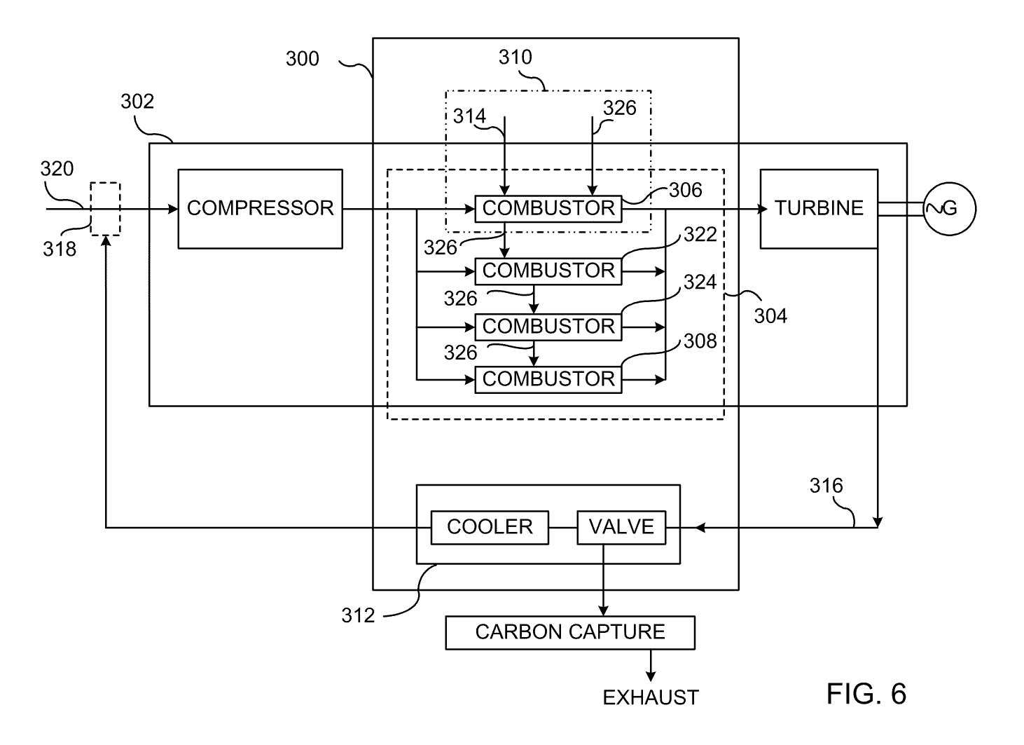

FIG. 6 is a schematic illustration of an exemplary configuration of multiple combustors in a gas turbine 102 of FIG. 1 including a system 300 for improving emission performance. A gas turbine 302 of FIG. 6 includes a multiple combustor combustion system 304. The multiple combustor combustion system 404 further includes at least two combustors 306, 308. The system 300 for improving emission performance in the gas turbine 302 includes a diluent addition system 310 and an exhaust gas recirculation system 312. The diluent addition system 310 adds diluent 314 to at least one of a combustor 306 of the multiple combustor combustion system 304. In an exemplary operation of the gas turbine 102, the exhaust gas recirculation system 312 recirculates less than about 50% of an exhaust gas stream 316 into the intake 318 of the gas turbine 302. Furthermore, the addition of diluent 314 into the multiple combustor combustion system 304 of gas turbine 302 reduces the concentration of NOx, for example by between about 80% to about 90% in the exhaust gas stream 316.

The formation of NOx within the combustor 306 increases exponentially with the flame temperature within the combustor 306. By addition of the diluent 314 into the combustor 306, the flame temperature within the combustor 306 decreases and reduces the formation of NOx, for example by between about 60% to about 70%. Lean blow out occurs by the reduction in oxygen content in a feed oxidant stream 320. The recirculation of exhaust gas stream 316 reduces the oxygen content in the feed oxidant stream 320 by about 5%. Furthermore the reduced flame temperature and oxygen content within the combustor 306 reduces the combustion efficiency of the combustor 306 and hence reduces the power output of the gas turbine 302. To produce adequate power output and also generate lower NOx emissions the diluent injection system 310 adds diluent 314 to at least one of the combustors 306 of the multiple combustor combustion system 304 to reduce NOx, for example by between about 80% to about 90% while other combustors 308, 322, 324 of the exemplary multiple combustor combustion system 404 combust a mixture of fuel stream 326 and feed oxidant stream 320 without the influence of diluent 314.

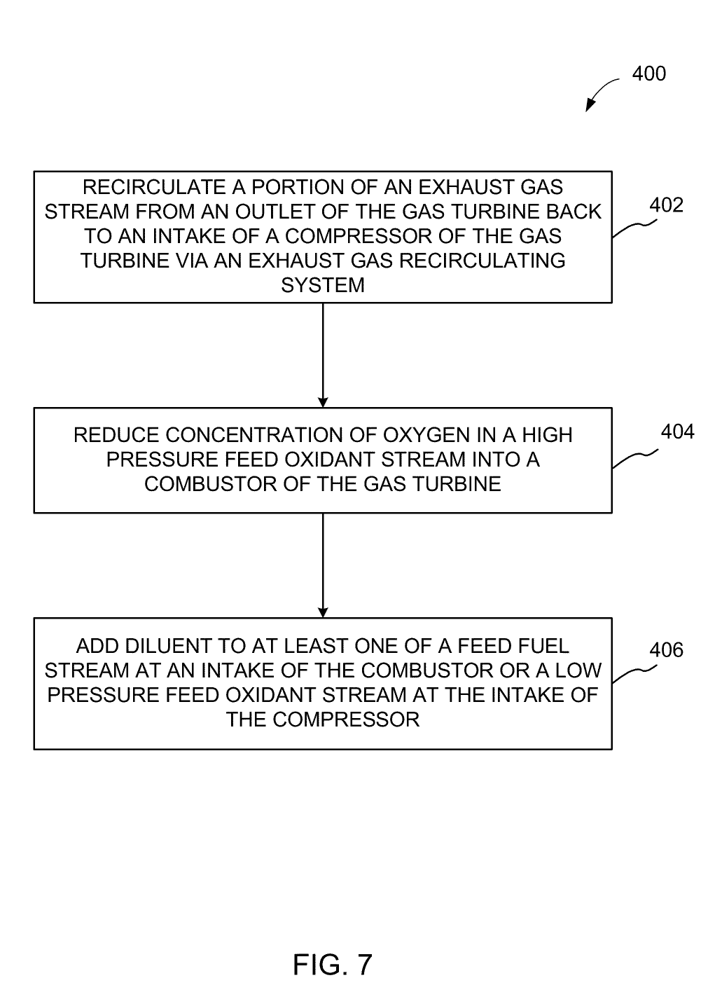

FIG. 7 is a flow chart illustrating exemplary steps for a method 400 of improving emission performance of a gas turbine engine. The method 400 includes recirculating a portion of an exhaust gas stream to a compressor of the gas turbine via an exhaust gas recirculating system in the step 402. In a particular embodiment of this invention, the recirculating includes regulating a flow of exhaust gas stream with a valve. In another embodiment of this invention the recirculating includes cooling the exhaust gas stream in a cooler. Next, the concentration of oxygen is reduced in a high pressure feed oxidant stream into a combustor of the gas turbine in step 404. Finally, a diluent is added to at least one of a fuel stream directed to a combustor or a low pressure feed oxidant stream directed to the compressor in step 406. In a particular embodiment of this invention, adding diluent includes adding diluent to at least one of the recirculating exhaust gas stream or the low pressure feed oxidant stream or the fuel stream. In another embodiment of this invention, the adding diluent includes, adding diluent to fuel in a 1:1 ratio. In an exemplary embodiment, the method reduces a concentration of oxides of nitrogen (NOx) in an exhaust gas stream to less than about 3 ppm. In another exemplary embodiment, a concentration of carbon dioxide is increased by about 10%.

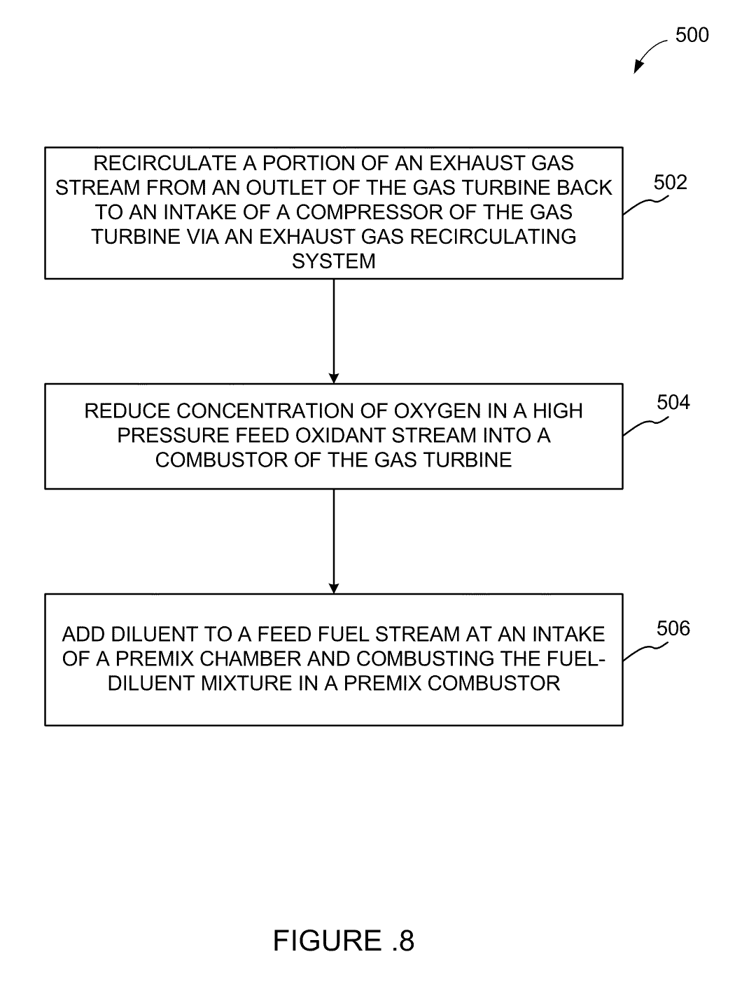

FIG. 8 is a flow-chart, illustrating exemplary steps for another exemplary method of improving emission performance of a gas turbine engine. The method 500 includes recirculating a portion of an exhaust gas stream to a compressor of the gas turbine via an exhaust gas recirculating system in step 502. Next, a concentration of oxygen is reduced in a high pressure feed oxidant stream directed to a combustor of the gas turbine in step 504. In a particular embodiment of this invention, recirculating includes regulating a flow of exhaust gas stream with a valve. In another embodiment of this invention, recirculating includes cooling the exhaust gas stream in a cooler. Finally, a diluent is added to a fuel stream directed to a premix chamber and combusting the fuel-diluent mixture in a premix combustor in step 506. In a particular embodiment of this invention, adding diluent includes adding diluent at the intake of the premix combustor. In a particular embodiment, the concentration of oxides of nitrogen (NOx) in an exhaust gas stream is reduced to less than about 3 ppm. In another particular embodiment, the concentration of carbon dioxide is increased by about 10%.

### EXAMPLES

The examples that follow are merely illustrative and should not be construed to limit the scope of the claimed invention.

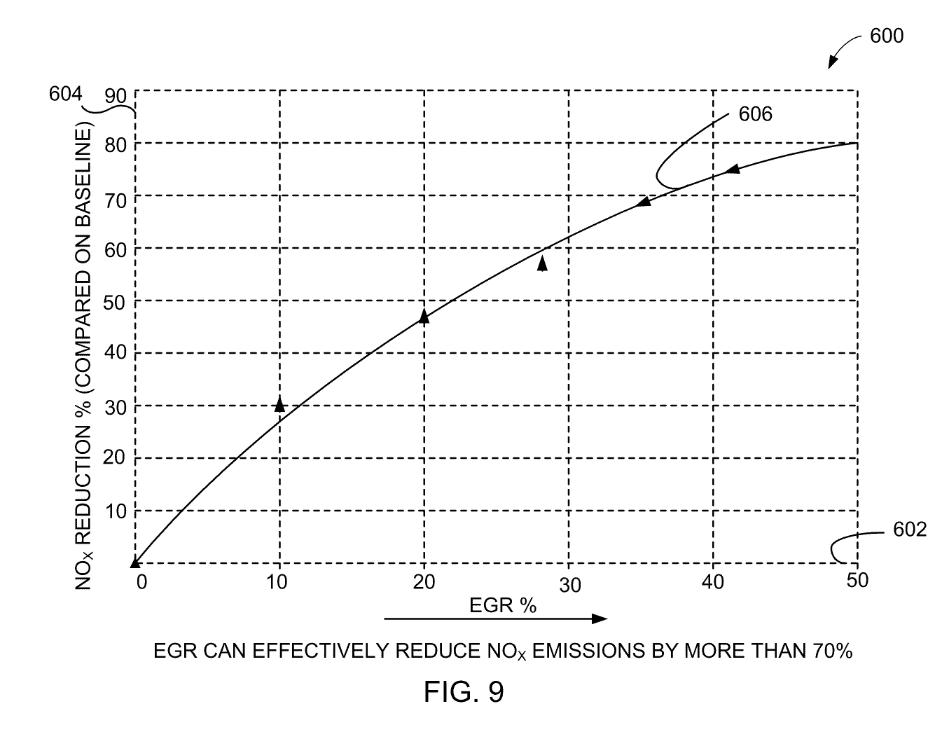

FIG. 9 is a graphical representation 600 of percentage reduction in NOx formation with percentage increase in exhaust gas recirculation. The X-axis 602 represents percentage increase in exhaust gas recirculation. The Y-axis 604 represents percentage reduction in NOx formation. Curve 606 represents the variation in NOx formation with respect to the variation in exhaust gas recirculation. As illustrated by curve 606, the percentage increase in exhaust gas recirculation increases with percentage reduction in NOx formation. For example, the formation of NOx is reduced by about 80%, at about 50% of exhaust gas recirculation. Similarly, there is a 25% NOx reduction at a lower exhaust gas recirculation of about 10%. Thus, the increase in exhaust gas recirculation reduces the NOx formation in a gas turbine engine.

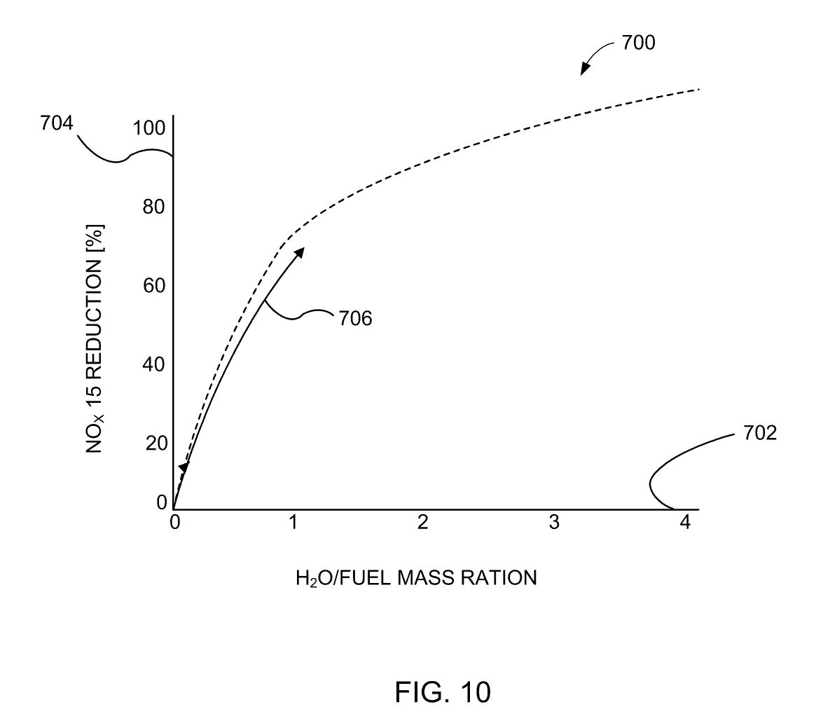

FIG. 10 is a graphical representation 700 of percentage reduction in NOx formation with increase in ratio of water or steam with fuel. The X-axis 702 represents diluent to fuel ratio. The Y-axis 704 represents percentage reduction in NOx formation. Curve 706 represents the variation in NOx formation with increasing ratio of diluent to fuel. In a particular embodiment, the diluent includes water or steam. As depicted by curve 706, the increase in ratio of diluent to fuel increases the percentage reduction in NOx formation. For example, the formation of NOx is reduced by about 70% at about 1:1 ratio of diluent to fuel. Thus, the increase in diluent to fuel ratio reduces the NOx formation in a gas turbine engine.

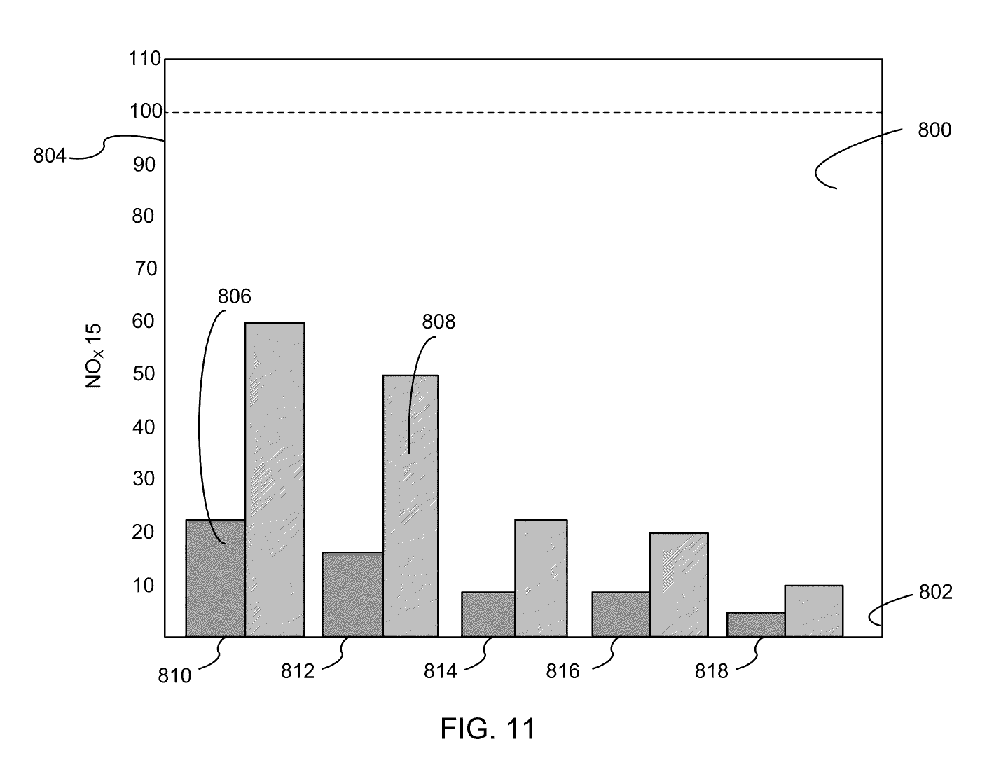

FIG. 11 is a graphical representation 800 of the reduction in NOx formation with increasing percentage of exhaust gas recirculation and steam or water to fuel ratio. The X-axis 802 represents various operational conditions at which percentage exhaust gas recirculation and ratio of steam or water to fuel ratio is varied. The Y-axis 804 represents the percentage NOx formation. The bar 806 represents NOx formation due to premix combustion and the bar 808 represents NOx formation in diffusion combustion. A first operational condition 810 includes zero percentage EGR and steam or water to fuel ratio is 1:1. As illustrated herein, the NOx formation is about 20% due to premixed combustion and about 60% due to diffusion combustion at the operational condition 810. In a second operational condition 812, the EGR is about 25% without any diluent addition. The NOx formation is about 16% due to the premixed combustion and about 50% due to diffusion combustion at the operational condition 812. Similarly, in a third operational condition 814 the EGR is about 40% without any diluent addition. The NOx formation is about 5% due to the premixed combustion and about 24% due to diffusion combustion at the third operational condition 814. The fourth operational condition 816 includes a 25% percentage EGR and steam or water to fuel ratio is maintained at 1:1. As depicted, the NOx formation is about 4% due to the premixed combustion and about 20% due to diffusion combustion at the operational condition 816. In the fifth operational condition 818, the EGR is about 40% with steam or water to fuel ratio maintained at about 1:1. The NOx formation is about 2% due to the premixed combustion and about 9% due to diffusion combustion at the operational condition 818. Thus, the combination of EGR and diluent addition with the fuel stream collectively reduces NOx formation to a greater extent in comparison to NOx reduction using only EGR or only diluent addition within a gas turbine.

The various embodiments of a system and method of improving emission performance of a gas turbine described above thus provide a way to reduce the concentration of oxides of nitrogen (NOx) in an exhaust gas stream by less than about 3 ppm and increase concentration of carbon dioxide by about 10%. The technique also enables economical employment of carbon capture techniques. Furthermore, the system and method provide a retrofit system for existing gas turbine based power generation systems to generate lower NOx of less than about 3 ppm, thereby enabling the highly polluting power generation systems to economically control NOx production and thus meet stringent environmental regulations.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of diluents like steam, water or other diluents like nitrogen for example, described with respect to one embodiment, can be used with EGR cooler, described with respect to another embodiment of the invention. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of improving emission performance of a gas turbine, the method comprising:
recirculating a portion of an exhaust gas stream to a compressor of the gas turbine via an exhaust gas recirculating system to reduce the concentration of oxygen in a high pressure feed oxidant stream into a combustor of the gas turbine; and
adding diluent to at least one of a fuel stream directed to the combustor or a low pressure feed oxidant stream directed to the compressor to reduce the concentration of oxides of nitrogen (NOx) and increase the concentration of carbon dioxide in a resultant exhaust gas stream.

2. The method of claim 1, wherein said recirculating comprises regulating a flow of exhaust gas stream with a valve.

3. The method of claim 1, wherein said recirculating comprises cooling the exhaust gas stream in a cooler.

4. The method of claim 1, wherein, said adding diluent comprises adding diluent to the at least one of the recirculating exhaust gas stream or the low pressure feed oxidant stream or the fuel stream.

5. The method of claim 1, wherein said adding diluent comprises adding diluent to fuel in a 1:1 ratio.

6. The method of claim 1, wherein said reduce the concentration of NOx in the exhaust gas stream comprises reducing to less than about 3 ppm.

7. The method of claim 1, wherein said increasing the concentration of carbon dioxide in a resultant exhaust gas stream comprises increasing the concentration by about 10%.

8. A method of improving emission performance of a gas turbine, the method comprising:
recirculating a portion of an exhaust gas stream to a compressor of the gas turbine via an exhaust gas recirculating system, to reduce the concentration of oxygen in a high pressure feed oxidant stream into a combustor of the gas turbine; and
adding diluent to a fuel stream directed to a premix chamber and combusting the fuel-diluent mixture in a premix combustor, to reduce the concentration of oxides of nitrogen (NOx) and increase concentration of carbon dioxide in the resultant exhaust gas stream.

9. The method of claim 8, wherein said reduce the concentration of NOx in the exhaust gas stream comprises reducing to less than about 3 ppm.

10. The method of claim 8, wherein said increasing the concentration of carbon dioxide in a resultant exhaust gas stream comprises increasing the concentration by about 10%.

11. The method of claim 8, wherein said recirculating comprises regulating a flow of exhaust gas stream with a valve.

12. The method of claim 8, wherein said recirculating comprises , cooling the exhaust gas stream in a cooler.

13. The method of claim 8, wherein said adding diluent comprises adding diluent at the intake of the premix combustor.

14. A system for improved emission performance of a gas turbine, the system comprising:
an exhaust gas recirculation system configured to recirculate a portion of an exhaust gas stream to a compressor of the gas turbine, to reduce concentration of oxygen in a high pressure feed oxidant stream into a combustor of the gas turbine; and
a diluent addition system configured to add a diluent to at least one of a fuel stream directed to the combustor or a low pressure feed oxidant stream directed to the compressor, to reduce the concentration of oxides of nitrogen (NOx) and increase concentration of carbon dioxide in a resultant exhaust gas stream.

15. The system of claim 14, wherein said recirculation system comprises a valve to regulate a flow of exhaust gas stream.

16. The system of claim 14, wherein said recirculation system comprises a cooler to cool the exhaust gas stream.

17. The system of claim 14, wherein said diluent comprises steam or water.

18. The system of claim 14, wherein said fuel stream comprises at least one of a liquid fuel or a gaseous fuel.

19. The system of claim 14, wherein said diluent addition system comprises a mixer configured to mix the diluent with the fuel stream.

20. The system of claim 14, wherein said exhaust gas recirculation system and diluent addition system together reduces the concentration of NOx in the exhaust gas stream to less than about 3 ppm.

21. The system of claim 14, wherein said exhaust gas recirculation system increases the concentration of carbon dioxide in a resultant exhaust gas stream by about 10%.

22. A system for improved emission performance of a gas turbine, the system comprising:
an exhaust gas recirculation system configured to recirculate a portion of an exhaust gas stream to a compressor of the gas turbine, to reduce concentration of oxygen in a high pressure feed oxidant stream into a combustor of the gas turbine; and
a diluent addition system configured to add a diluent to a fuel stream at a premix chamber within the combustor, to reduce concentration of oxides of nitrogen (NOx) and increase concentration of carbon dioxide in a resultant exhaust gas stream.

23. The system of claim 22, wherein said recirculation system comprises a valve to regulate flow of exhaust gas stream.

24. The system of claim 22, wherein said recirculation system comprises a cooler to cool the exhaust gas stream.

25. The system of claim 22, wherein said diluent comprises steam or water.

26. The system of claim 22, wherein said fuel stream comprises at least one of a group of liquid or gaseous fuels.

27. The system of claim 22, wherein said diluent addition system is further configured to add the diluent at the intake of the premix combustor.

28. The system of claim 22, wherein said diluent addition system comprises a mixer configured to mix the diluent with the fuel stream.

29. The system of claim 22, wherein said exhaust gas recirculation system and diluent addition system together reduces the concentration of NOx in the exhaust gas stream to less than about 3 ppm.

30. The system of claim 22, wherein said exhaust gas recirculation system increases the concentration of carbon dioxide in a resultant exhaust gas stream by about 10%.

31. A system for improved emission performance in power generation, the system comprising:
at least two gas turbine engines;
a diluent addition system configured to add a diluent to at least one of a fuel stream at a first and second gas turbine combustor or a low pressure feed oxidant stream at a first and second gas turbine compressor intake; and
an exhaust gas recirculation system configured to recirculate a portion of an exhaust gas stream from a first gas turbine outlet into the first gas turbine compressor intake, and circulate a portion of the exhaust gas stream of the first gas turbine at the second gas turbine compressor intake, to reduce concentration of oxygen in a high pressure feed oxidant stream into the first and second gas turbine combustors and reduce the concentration of oxides of nitrogen (NOx) and increase concentration of carbon dioxide in the exhaust gas streams of the first and second gas turbines.

32. The system of claim 31, wherein said recirculation system comprises a bypass valve to bypass the flow of the first gas turbine exhaust gas stream .

33. The system of claim 31, wherein said recirculation system comprises a valve to regulate the flow of the first gas turbine exhaust gas stream.

34. The system of claim 31, wherein said recirculation system comprises a cooler to cool the exhaust gas stream.

35. The system of claim 31, wherein said exhaust gas recirculation system and diluent addition system together reduces the concentration of NOx in the exhaust gas stream is reduced to less than about 3 ppm.

36. The system of claim 31, wherein said exhaust gas recirculation system increases the concentration of carbon dioxide in a resultant exhaust gas stream by about 10%.

37. A retrofit system for improved emission performance of a gas turbine, the retrofit system comprising:
a retrofittable exhaust gas recirculation system, configured to recirculate a portion of an exhaust gas stream to a compressor of the gas turbine, to reduce concentration of oxygen in a high pressure feed oxidant stream into a combustor of the gas turbine; and
a retrofittable diluent addition system configured to add a diluent to at least one of a fuel stream directed to the combustor or a low pressure feed oxidant stream directed to the compressor, to reduce concentration of oxides of nitrogen (NOx) and increase concentration of carbon dioxide in a resultant exhaust gas stream.

38. A system for improved emission performance of a gas turbine, the system comprising:
at least two combustors;
an exhaust gas recirculation system configured to recirculate a portion of an exhaust gas stream to a compressor of the gas turbine, to reduce concentration of oxygen in a high pressure feed oxidant stream into one or more of the at least two combustors of the gas turbine; and
a diluent addition system configured to add a diluent to one or more of the at least two combustors of the gas turbine, to reduce the concentration of oxides of nitrogen (NOx) and increase concentration of carbon dioxide in a resultant exhaust gas stream .
